(19) United States
(12) Patent Application Publication
(10) Pub. No.: US 2026/0035214 A1
(43) Pub. Date: Feb. 5, 2026

(54) FRAMELESS COUNTERWEIGHT AND ELEVATOR SYSTEM

(71) Applicant: Otis Elevator Company, Farmington, CT (US)

(72) Inventor: Salvador Garcia León, Leganés, Madrid (ES)

(21) Appl. No.: 19/284,857

(22) Filed: Jul. 30, 2025

(30) Foreign Application Priority Data
Aug. 2, 2024 (EP) 24382861.3

(51) Int. Cl. B66B 17/12

(52) U.S. Cl. CPC B66B 17/12

(57) ABSTRACT

A counterweight (1) for an elevator system (10). The counterweight (1) includes several stacked weight components (2), and a holding device (3) for holding the weight components (2) relative to each other. The holding device (3) has at least one fastening rod (4) penetrating at least one of the weight components (2) and fastening the weight components (2) relative to each other.

### FOREIGN PRIORITY

This application claims priority to European Patent Application No. 24382861.3, filed Aug. 2, 2024, and all the benefits accruing therefrom under 35 U.S.C. § 119, the contents of which in its entirety are herein incorporated by reference.

### TECHNICAL FIELD OF INVENTION

The disclosure relates to a counterweight for an elevator system, as well as an elevator system having an elevator car and such a counterweight.

### BACKGROUND OF THE INVENTION

It is well known that counterweights for elevators are composed of several elements/components/fillers forming weights. Usually, a frame construction is provided into which the elements are inserted one after the other. The assembled counterweights have a relatively complex structure with individual components that are relatively costly to manufacture.

In this respect, it is an object of the present disclosure to provide an improved counterweight where the known disadvantages of the prior art are avoided.

This is solved by a counterweight and an elevator system according to the independent claims. Preferred embodiments are subject matter of the dependent claims.

### SUMMARY OF THE INVENTION

According to an aspect a counterweight for an elevator system is provided. The counterweight comprises on the one hand several weight components/elements/fillers arranged on top of each other/stacked on top of each other. The weight components can be plate-shaped or block-shaped. Also, a holding device is provided for holding/fixing the weight components relative to each other. The holding device thus connects the weight components into a single-piece unit. The holding device has at least one fastening rod penetrating at least one of the weight components and fastening the weight components relative to each other. This fastening rod makes it possible to construct the holding device with the simplest possible means. In particular, complex frame elements made of multi-dimensional profiles can be avoided. This makes the counterweight much easier to manufacture. At the same time, the structure of the counterweight can be significantly simplified.

According to an aspect two fastening rods are provided. The two fastening rods may be positioned in holes of the plate-shaped or block-shaped weight components. This achieves a good compromise between a sufficient holding force and a small number of assembled components.

According to an aspect the at least one fastening rod protrudes out of the stack of weight components on a top side or a bottom side or on both of these sides. In other words, the at least one fastening rod can protrude through the weight components. The fastening rod or the two fastening rods can protrude through all, or at least the uppermost weight component and the lowermost weight component. This makes it possible to design the weight components as large as possible, in particular over the overall width of the counterweight, and at the same time to integrate the holding device compactly.

According to an aspect the at least one fastening rod penetrates each of the stacked weight components through a respective hole and/or the hole is configured as a through hole (like a drill hole).

According to an aspect the hole is opened towards a side of the weight component, which opening has a smaller diameter than the hole itself. This makes the assembly of the counterweight much easier.

According to an aspect at least one fastening rod includes a constriction region at a certain position seen in a longitudinal direction of this fastening rod, wherein a minimum diameter of this fastening rod at the constriction region is smaller than (a width of) the opening of the weight component. This makes the assembly of the counterweight even more easy.

According to an aspect an uppermost weight component and/or a lowermost weight component are/is provided with an anchoring point, like a pulley, for directly or indirectly fixing/attaching/receiving a tension member, like a cable pull. This further simplifies the structure.

According to an aspect two weight components are provided with protruding guide shoes, rollers or other devices used to constrain an undesired lateral displacement of the counterweight. The guide shoes, rollers or other devices can be attached to an uppermost weight component and/or a lowermost weight component. This even further simplifies the structure.

According to an aspect a lowermost weight component is provided with at least one buffer device, such as a bumper. In total, even more than one buffer device can be provided, like two or even more than two buffer devices in the same counterweight. In addition, this feature simplifies the structure.

According to an aspect the at least one fastening rod is provided with an external thread at least on a part of the length of the rod or completely along the length of the rod. The threaded rod can thus be provided as continuous threaded rod (having a thread that runs continuously from a first end to a second end of the rod). Alternatively, the threaded rod can be provided with several thread sections that are spaced in longitudinal direction of the rod from each other.

According to an aspect the at least one fastening rod is provided as hollow rod. Otherwise, the at least one fastening rod can also be provided as a solid rod (full material). Moreover, only two rods arranged in parallel can be used for fastening the weight components relative to each other.

According to an aspect the at least one fastening rod can be covered with a cap at least at one end.

According to an aspect the cap is provided as threaded nut (receiving a thread of the fastening rod).

According to an aspect the uppermost and lowermost weight components are provided as structural parts of the frameless holding device. This means that the uppermost and lowermost weight components are directly used as part of the holding device, pressing the weight components, which are arranged in between, together.

According to an aspect an elevator system is provided that comprises an elevator car and a counterweight. The counterweight is prepared for being coupled to the elevator car by means of a tension member.

The claimed counterweight is therefore focused on a simpler design. Two threaded stud rods (fastening rods) are provided for fixation. The threaded rods are placed through holes in the weight fillers. In addition, an additional lower plank and an upper crosshead are avoided and replaced for a weight filler with holes placed to join with bolts, the sheave shaft system or the buffer.

In both cases the disclosure takes advantage of the weight fillers' stiffness and geometry which are more robust than shell components.

This results in a counterweight having a huge reduction in the manufacturing effort since there are less components and there is a reduction of the time needed to assemble the counterweight because of the extra simplicity of the design. In addition, the design is safer, more robust with higher stiffness.

### BRIEF DESCRIPTION OF THE DRAWINGS

Embodiments of the present disclosure, as an example only, will be described in the following with reference to the drawings. In the drawings:

FIG. 1 shows a perspective view of a simplified illustrated counterweight including several weight components, wherein merely the lowermost and the uppermost weight components are shown so that two fastening rods of a holding device fixing all weight components relative to each other can be recognized;

FIG. 2 shows a top view of one weight component that is present in a plurality in the design according to FIG. 1, wherein holes for passing through the fastening rods are provided and these holes are opened towards a side of the weight component;

FIG. 3 shows a perspective view of a constriction region of the fastening rod used in FIG. 1 and being provided with flattenings causing a reduced diameter so that the rod can pass through the opening of the weight component;

FIG. 4 shows a side view of the fastening rod of FIG. 3 in the area of the constriction region in the upper area and a top view of this fastening rod in the lower area so that the flattenings become more apparent;

FIG. 5 shows a perspective view of an upper area of the counterweight of FIG. 1 showing that the uppermost weight component is provided with a pulley for receiving a tension member and with protruding guide shoes; and

FIG. 6. shows a detailed perspective view of a lower area of the counterweight of FIG. 1 showing a guide shoe in detail.

### DETAILED DESCRIPTION OF THE INVENTION

In the following, embodiments of the present disclosure are explained with reference to the drawings. The same elements are assigned with the same reference numbers in the drawings. It is to be noted, that the embodiments are described for exemplary purposes only and the description of the embodiments is not intended to limit the scope of the present disclosure.

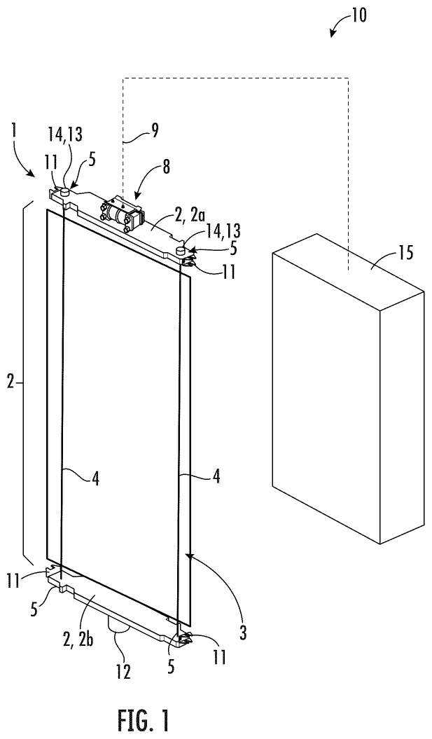

FIG. 1 shows the structure of a counterweight 1. In this exemplary embodiment, the counterweight 1 is used in an elevator system 10 and shown as coupled to an elevator car 15 via a tension member 9 as is known in the art.

This elevator system 10 usually has further components, for example guide rails (not shown) for guiding the counterweight 1 and the elevator car 15 during their up and down movements.

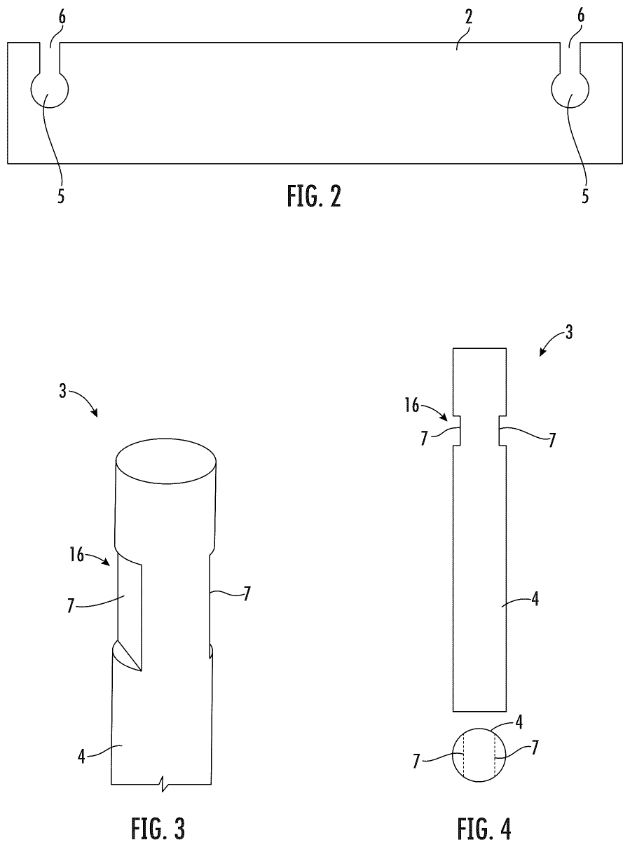

The counterweight 1 has a large number of stacked weight components 2, which can be seen in more detail in FIGS. 2, 5 and 6. For the sake of clarity, only the top weight component 2a and the bottom weight component 2b of this stack are shown in FIG. 1, so that two fastening rods 4 of the holding device 3, which secures those weight components 2 in relation to each other, can be seen.

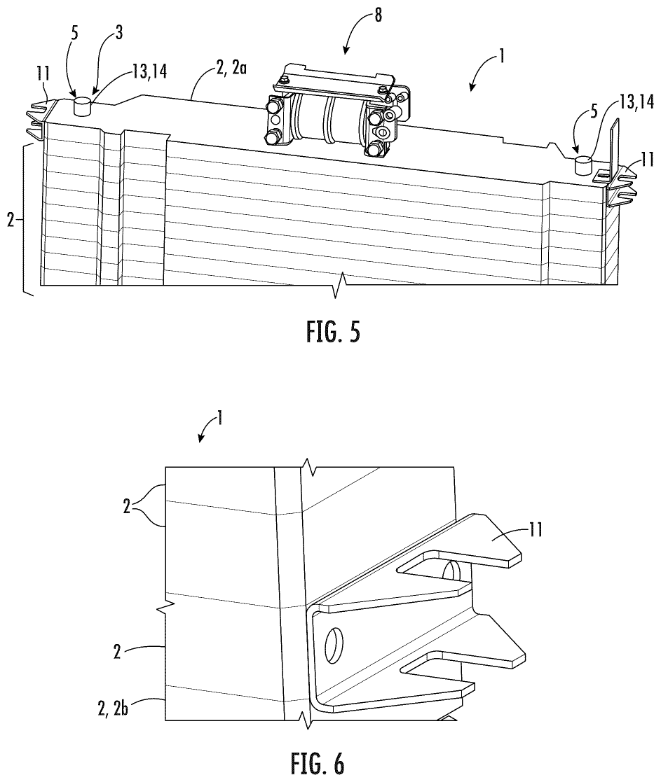

With reference to FIG. 5, the individual weight components 2 can be plate-shaped. can be made of a metal, such as steel. The weight components 2 can be made of a metal, such as steel. Alternatively or additionally, weight components 2 made of concrete can be used. However, all weight components 2 are similar or even identical in terms of their outer contour when viewed from the top. As a result, the weight components 2 can form a uniform composite when assembled, which composite can have a continuous outer contour along its length. When using both weight components 2 made out of steel and weight components 2 made out of concrete, on the one hand (at least the most of) the weight components 2 made out of steel can be designed as identical parts among each other and, on the other hand, (at least the most of) the weight components 2 made of concrete can be designed as identical parts among each other.

The holding device 3, which essentially consists of the two fastening rods 4 and the corresponding associated nuts 14, is provided for connecting/fixing the individual weight components 2 to each other.

The structure and function of the holding device 3 can be seen particularly clearly in FIGS. 1 to 4. Each fastening rod 4 projects through a plurality of through holes 5 arranged in longitudinal/axial alignment with each other. In this embodiment, each weight component 2 is equipped with such a hole 5, although it is also possible that only some of the weight components 2 are equipped with such holes 5.

According to FIG. 2, the respective hole 5 can also be open to one side (of the counterweight 1) and can thus be provided with an opening 6. This opening 6 is realized as an elongated hole and has a smaller width than the diameter of the hole 5. This opening 6 is used in particular, as can be seen below with reference to FIGS. 3 and 4, for easier mounting of the weight components 2 on the fastening rods 4.

Matching the opening 6 of the respective weight component 2, each fastening rod 4 has a constriction region 16 comprising one or here even two flattenings 7. This constriction region 16 provides a local diameter reduction of the fastening rod 4 along its longitudinal direction. In the area of the constriction region 16 the fastening rod 4 is smaller in diameter than the width of the opening 6.

Since the constriction region 16 is arranged in an upper end area of the fastening rod 4, all weight components 2 can be pushed onto the fastening rods 4 during assembly by a transverse displacement relative to the fastening rods 4, so to speak, and then placed downwards onto the other weight components 2.

Each fastening rod 4 is designed as a threaded rod. This threaded rod can be implemented continuously, i.e. with a thread along its entire length (with a local exception in the area of the flattenings 7). Alternatively, however, it is also possible to provide the fastening rod 4 with threaded sections only in single regions (in its longitudinal direction), in particular at its upper and lower ends, where they are screwed into nuts 14.

For the final fixing of the fastening rods 4, the fastening rods 4 protrude towards the bottom and the top of the stack of weight components 2 with a certain section, to which the nuts 14 are then finally screwed on, thus press the weight components 2 finally together and fix them to each other. In further embodiments, however, it is also possible in principle to dispense of the nuts 14 and screw the fastening rods 4 directly into a thread of an uppermost and/or lowermost weight component 2a, 2b, for example.

The nuts 14 can be equipped directly as end caps 13, which protect the fastening rods 4 from external corrosion.

The uppermost weight component 2a is further provided with an anchoring point 8 for fixing the tension member 9 (at its upper side). The anchoring point 8 can be provided as pulley. In further embodiments, an anchoring point 8 may additionally or alternatively be arranged on an underside of the lowermost weight component 2b.

Furthermore, two guide shoes 11 are attached to the uppermost weight component 2a. Each guide shoe 11 protrudes laterally on one of two sides of the uppermost weight component 2a facing away from each other, as can be seen in FIG. 5.

With reference to FIG. 6, it can also be seen that it is also possible to place two further guide shoes 11, which again protrude laterally, on other weight components 2 arranged between the uppermost weight component 2a and the lowermost weight component 2b. It is also possible to place guide shoes 11 on the lowermost weight component 2b. The guide shoes 11 are typically guided along guide rails (not shown) during operation.

In total, there can be four guide shoes 11 provided, namely two in the upper half and two in the lower half of the length/height of the counterweight 1.

The lowermost weight component 2b is also provided with a bumper 12 on its underside.

The two fastening rods 4 are ultimately accommodated in the weight components 2 in such a way that the outer/lateral contours of the counterweight 1 (in particular the contour between the uppermost weight component 2a and the lowermost weight component 2b) are largely unaffected by the fastening rods 4 (with the exception of the sections screwed into the nuts 14 at the top and bottom).

In this regard, it should be noted that the directional information used here-bottom/bottom side/lower/lower side and top/top side/upper/upper side-refers to the intended installation position of the counterweight 1 in relation to the acting gravitational field.

What is claimed is:

1. A counterweight (1) for an elevator system (10), the counterweight (1) comprising:
several stacked weight components (2), and
a holding device (3) for holding the weight components (2) relative to each other,
wherein the holding device (3) has at least one fastening rod (4) penetrating at least one of the weight components (2) and fastening the weight components (2) relative to each other.

2. The counterweight (1) according to claim 1, wherein two fastening rods (4) are positioned in holes (5) of the plate-shaped or block-shaped weight components (2).

3. The counterweight (1) according to claim 1, wherein the at least one fastening rod (4) protrudes out of the stack of weight components (2) on a top side or a bottom side or on both of these sides.

4. The counterweight (1) according to claim 2, wherein the at least one fastening rod (4) penetrates each of the stacked weight components (2) through a respective hole (5) and/or that the hole (5) is configured as a through hole.

5. The counterweight (1) according to claim 4, wherein the hole (5) is opened towards a side of the weight component (2), which opening (6) has a smaller diameter than the hole (5) itself.

6. The counterweight (1) according to claim 5, wherein the at least one fastening rod (4) includes a constriction region (16) at a certain position seen in a longitudinal direction of this fastening rod (4), wherein a minimum diameter of this fastening rod (4) at the constriction region (16) is smaller than the opening (6) of the weight component (2).

7. The counterweight (1) according to claim 1, wherein an uppermost weight component (2a) and/or a lowermost weight component (2b) are/is provided with an anchoring point (8) for directly or indirectly fixing a tension member (9).

8. The counterweight (1) according to claim 1, wherein two weight components are provided with protruding guide shoes (11).

9. The counterweight (1) according to claim 1, wherein a lowermost weight component (2b) is provided with a bumper (12).

10. The counterweight (1) according to claim 1, wherein the at least one fastening rod (4) is provided with an external thread at least on a part of the length of the rod (4) or completely along the length of the rod (4).

11. The counterweight (1) according to claim 1, wherein the at least one fastening rod (4) is provided as a hollow rod and/or only two parallel arranged rods (4) are used for fastening the weight components (2) relative to each other.

12. The counterweight (1) according to claim 1, wherein the at least one fastening rod (4) is covered with a cap (13) at least at one end.

13. The counterweight (1) according to claim 12, wherein the cap (13) is provided as threaded nut (14).

14. The counterweight (1) according to claim 1, wherein the uppermost and lowermost weight components (2a, 2b) are provided as structural parts of the frameless holding device (3).

15. An elevator system (10) comprising an elevator car (2) and a counterweight (1) according to claim 1, wherein the counterweight (1) is prepared for being coupled to the elevator car (2) by means of a tension member (9).
